(19) United States
(12) Patent Application Publication
(10) Pub. No.: US 2009/0228438 A1
(43) Pub. Date: Sep. 10, 2009

(54) Method and Apparatus for Identifying if Two Websites are Co-Owned

(76) Inventors: Anirban Dasgupta, Berkeley, CA (US); Rajat Ahuja, San Jose, CA (US); Shanmugasundaram Ravikumar, Berkeley, CA (US); Su Han Chan, Sunnyvale, CA (US)

Correspondence Address: STATTLER - SUH PC, 60 SOUTH MARKET STREET, SUITE 480, SAN JOSE, CA, 95113, US

(21) Appl. No.: 12/044,339

(22) Filed: Mar. 7, 2008

(51) Int. Cl. G06F 7/06

(52) U.S. Cl. 707/3; 707/E17.108

(57) ABSTRACT

A method and apparatus are provided for identifying if two websites are co-owned. In one example, the method includes obtaining redirect URL (uniform resource locator) pairs from the Internet, constructing a training set using the redirect URL pairs, constructing a feature set based on the training set, and learning co-ownership decisions based on the feature set and the training set.

### FIELD OF THE INVENTION

The present invention relates to redirect pairs of URLs (uniform resource locators). More particularly, the present invention relates to identifying if redirect URL pairs are co-owned.

### BACKGROUND OF THE INVENTION

Redirecting URLs (uniform resource locators) is a very common phenomenon on the web. In dealing with redirects, a search engine, such as Yahoo!®, has to come up with well-specified policies on which URL to index the content under. The search engine must also decide the appropriate URL to display as part of the search results. The problem is nontrivial, as can be seen from the following two examples: http://www.rational.com (source URL) redirects to http://www-306.ibm.com/software/rational/ (target URL) as of Oct. 23, 2007, because IBM bought Rational Software; and spam websites like http://www.somespam.com (source URL) redirect to http://www.yahoo.com (target URL) as of Oct. 23, 2007.

In the first example of redirection, the search engine would like to index the anchor text under both the source URL and target URL. The search engine may also like to display the source URL in search results because the source URL is a root page and may, therefore, improve user experience.

On the other hand, in the second example, the search engine would not like to associate the anchor text from the source (somespam.com) with the target (yahoo.com). In case of a content match, the search engine would not care to show the source URL, but would rather show the target URL.

Yahoo!®, like any other search engine, has come up with a set of redirect policies. A key component in this decision-making is trying to learn whether the source and the target URLs are owned by the same entity, in other words, co-owned. Unfortunately, this learning process is not a trivial task.

### SUMMARY OF THE INVENTION

What is needed is an improved method having features for addressing the problems mentioned above and new features not yet discussed. Broadly speaking, the present invention fills these needs by providing a method and system for estimating whether, for redirecting the URL pairs, the source and target websites are co-owned. It should be appreciated that the present invention can be implemented in numerous ways, including as a method, a process, an apparatus, a system or a device. Inventive embodiments of the present invention are summarized below.

In one embodiment, a method of identifying if two websites are co-owned is provided. The method comprises obtaining redirect uniform resource locator pairs from the Internet, constructing a training set using the redirect uniform resource locator pairs, constructing a feature set based on the training set, and learning co-ownership decisions based on the feature set and the training set.

In another embodiment, an apparatus for identifying if two websites are co-owned is provided. The method comprises a web crawler device configured to obtain redirect uniform resource locator pairs from the Internet, a training set constructor device configured to construct a training set using the redirect uniform resource locator pairs, a feature set constructor device configured to construct a feature set based on the training set, and a co-ownership decisions learner device configured to learn co-ownership decisions based on the feature set and the training set.

In still another embodiment, a computer readable medium carrying one or more instructions for identifying if two websites are co-owned is provided. The one or more instructions, when executed by one or more processors, cause the one or more processors to perform the steps of obtaining redirect uniform resource locator pairs from the Internet, constructing a training set using the redirect uniform resource locator pairs, constructing a feature set based on the training set, and learning co-ownership decisions based on the feature set and the training set.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is an apparatus of a system for identifying if two websites are co-owned, in accordance with an embodiment of the present invention;

FIG. 2 is a training set that the system uses for identifying if two websites are co-owned, in accordance with an embodiment of the present invention; and

FIG. 3 is a flowchart of a method of identifying if two websites are co-owned, in accordance with an embodiment of the present invention.

### DETAILED DESCRIPTION OF THE INVENTION

An invention for a method and apparatus for identifying if two websites are co-owned is disclosed. Numerous specific details are set forth in order to provide a thorough understanding of the present invention. It will be understood, however, to one skilled in the art, that the present invention may be practiced with other specific details.

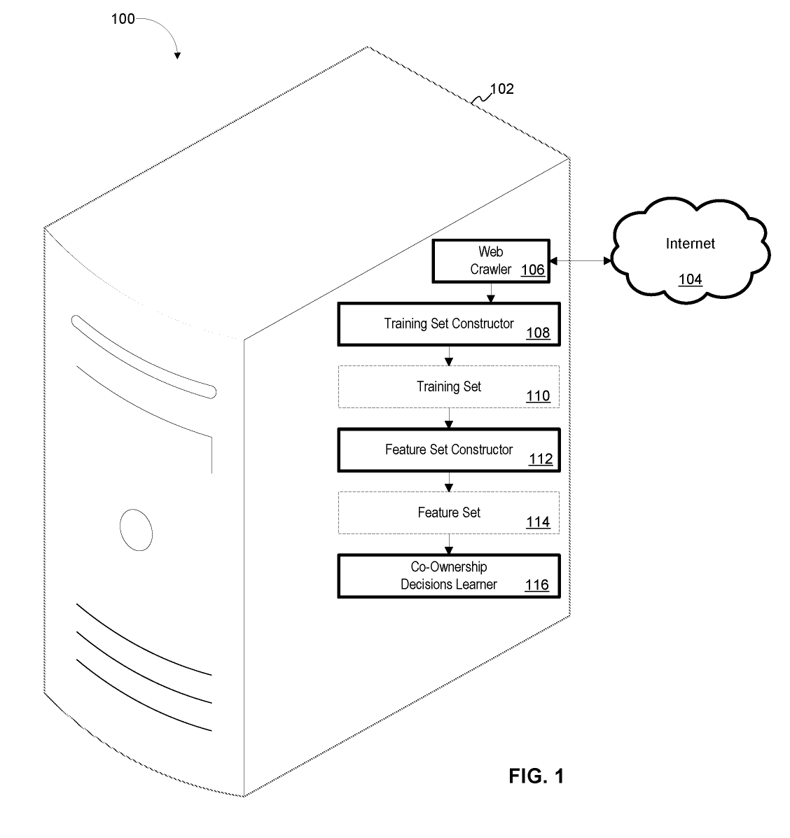

FIG. 1 is an apparatus 102 of a system 100 for identifying if two websites are co-owned, in accordance with an embodiment of the present invention. The apparatus 102 includes, among other things, a web crawler device 106, a training set device 108, a feature set constructor device 112, and a co-ownership decisions learner 116. The apparatus 102 shown here is a server. However, the system 100 may alternatively include a combination of servers, a general purpose computer and any other suitable combination of computing platforms.

A device is hardware, software or a combination thereof. Each device is configured to carry out one or more steps for identifying if two websites are co-owned. For explanatory purposes, FIG. 1 shows the system 100 as having one apparatus 102 with all the devices located therein. However, the devices of the apparatus 102 do not necessarily have to reside on one machine and may reside on separate machines on the Internet or on a network.

In a first part of the algorithm, the system constructs a training set 110. The web crawler device 106 is coupled to the Internet 104. The web crawler device 106 is a program or automated script which browses the Internet 104 in a methodical, automated manner and provides up-to-date data on URLs. Specifically, the web crawler device 106 browses the Internet 104 for redirect pairs of URLs. The web crawler device 106 provides these redirect pairs of URLs to the training set constructor device 108. The training set constructor device 108, at this point, has a set of examples of redirect pairs of URLs.

The system 100 needs to formulate its definition of co-ownership in order to label such redirect pairs. One possible way of determining co-ownership is using the registration information of the underlying domains. The system 100 can obtain this registration information via various Whois registrar feeds. Such registration data, although high quality, is relatively difficult to get and is expensive. Accordingly, a second option involves creating an editorially judged training set. The system 100 constructs a training set 110 using decidedly less sophisticated, but still effective, human intervention. A human goes through the redirect URL pairs and manually decides if each redirect URL pair is either co-owned or not co-owned.

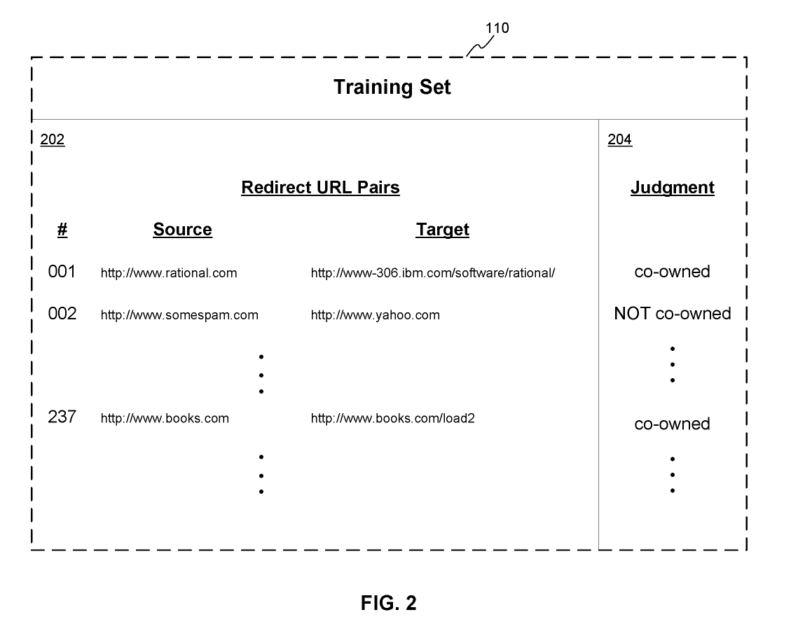

FIG. 2 is a training set 110 that the system uses for identifying if two websites are co-owned, in accordance with an embodiment of the present invention. The training set 110 includes a list of redirect URL pairs 202 and corresponding judgments 204 for the redirect URL pairs 202. Each redirect URL pair receives a judgment of either “co-owned” or “not co-owned”. As discussed above with reference to FIG. 1, the system obtains the judgments 204 by using either human editorials or data from the Whois registrar.

In the second part of the algorithm, the system 100 uses the training set 110 to construct a feature set 114 in order to automate the judgments made above in the first part of the algorithm. A feature set 114 is a is essentially a set of rules for training the system 100 to get to the ideal of human editorials discussed above with reference to FIG. 1. Referring again to FIG. 1, after the training set constructor device 108 constructs the training set 110, the system 100 learns co-ownership decisions by using features derived from the web-graphs and from the inlinks to the URLs of the training set 110. The feature set constructor device 112 receives the training set 110 and constructs a feature set 114 of co-ownership decisions.

The following methods are various techniques that the feature set constructor device 1 12 uses to construct a feature set 114. Through extensive analysis, it has been found that these methods of creating a feature set 114 are quite effective in learning co-ownership.

A first method of creating a feature set 114 involves analyzing URL overlap of the redirect URL pairs. The feature set constructor device 112 tokenizes the source and target URLs. The feature set constructor device 112 constructs a dictionary of all such tokens formed from a universe of URLs. Using this dictionary of URL tokens, the feature set constructor device 112, downweighs the most frequently occurring tokens, for instance, using tf-idf from the IR (Internet Registry) literature. Then the feature set constructor device 112 measures the similarity of the source and target URLs based on such a weighting function. If there is a statistically significant overlap between the source and target, this feature indicates a positive signal for co-ownership.

A second method of creating a feature set 114 involves analyzing DNS (domain name server) overlap. The feature set constructor device 112 looks at the ip-addresses of the two domain name servers that the two websites use. The feature set constructor device 112 regards each ip-address as a vector of length 4 in which each coordinate comes from the corresponding field of the ip-address. The feature set constructor device 112 computes the longest common prefix over pairs of such vectors, which one element of each pair comes from the source DNS, and one from the target. The feature set constructor device 112 computes the average (or maximum of the) longest common prefixes over all such pairs and returns this as the value of this feature.

A third method of creating a feature set 114 involves analyzing URL-anchor text overlap. Anchor text is the visible, clickable text in a hyperlink. Anchor text (i.e., text of the anchor) is the text a user clicks when clicking a link on a web page. Anchor text usually gives the user relevant descriptive or contextual information about the content of the link's destination. The anchor text may or may not be related to the actual text of the URL of the link. For example, a hyperlink to the main English Wikipedia page might take this form <a href=“http://www.wikipedia.org”>Wikipedia</a>. The anchor text in this example is Wikipedia; the complex URL http://www.wikipedia.org displays on the webpage as Wikipedia, contributing to a clean, easy to read text or document.

The feature set constructor device 112 looks at the inlinks of the source URL. An inlink is an incoming link to a website or webpage. Search engines often use the number of inlinks that a website has as one of the factors for determining that website's search engine ranking. The feature set constructor device 112 tokenizes the anchor text associated with these inlinks and again computes any statistically significant overlap with the anchor text and the tokens of the target URLs.

Spamminess of anchor text is an important consideration with the present invention. The system of the present invention utilizes machine learning to predict the co-ownership of two websites. Because the methods carried out by the system will be public information, the system is wide-open to be manipulated by spammers. Spammers could fairly easily designate several URLs to point to a spam webpage and have these several URLs falsely describe the spam webpage as being a non-spam webpage, such as the Yahoo!® home page. The spammer could thereby easily setup an instance of cloaking spam. Cloaking is getting a search engine to record content for a URL that is different than what a searcher will ultimately see, often done intentionally by spammers. To counter this problem, the system employs trust information about the anchor text that the system may use for cloaking spam that creates a false match. The system may employ, for example, the same kind of definitions that a search engine uses in a typical web search.

A fourth method of creating a feature set 114 involves analyzing spamness/goodness measures. The feature set constructor device 112 analyzes any sort of measure of how spammy or how trustworthy are each of the two websites (source and target). For example, if the source is a spam website and the target is not a spam website, then the particular redirect URL pair is likely not co-owned.

A fifth method of creating a feature set 114 involves analyzing the title in the webpage of the target URL. The feature set constructor device 112 takes the title of the target URL and attempts to match that title to the source URL. If the title matches the source URL, then presumably the particular redirect URL pair is co-owned.

Using one or more of the above methods for creating a feature set 114, the feature set 114 is then complete. Each of the features of the feature set 114 tends to prove whether a particular redirect URL pair is co-owned or not. The co-ownership decisions learner device 116 receives the feature set 114 and the training set 110. The co-ownership decisions learner device 116 preferably uses a standard machine learning model to learn the co-ownership decisions. The standard machine learning model uses information from the training set 110 and the feature 114 to learn the co-ownership decisions.

One example of standard machine learning model is a simple decision tree. For a particular redirect URL pair, the co-ownership decision learner device 116 takes the training set 110 and computes values for each feature of the feature set 114. The co-ownership decision learner device 116 then outputs a probability of the particular redirect URL pair being co-owned. The system 100 then has the complete algorithm for making co-ownership decisions.

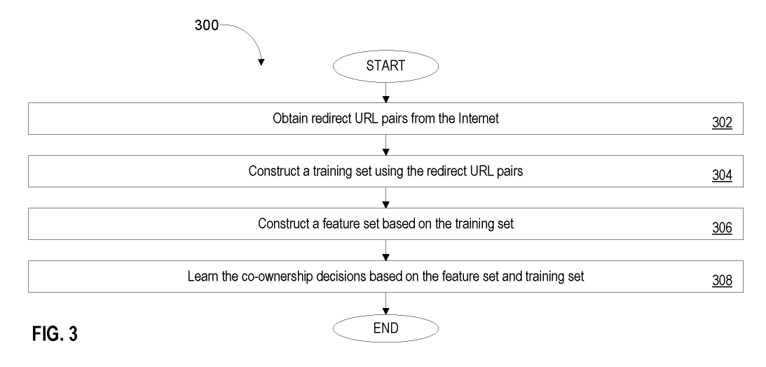

FIG. 3 is a flowchart of a method 300 of identifying if two websites are co-owned, in accordance with an embodiment of the present invention. The method 300 starts in step 302 where the system obtains redirect URL pairs from the Internet. The system may use the web crawler of FIG. 1 to obtain the redirect URL pairs. The method 300 then moves to step 304 where the system constructs a training set using the redirect URL pairs. The system may use the training set creator 108 of FIG. 1 to create the training set. Next, in step 306, the system constructs a feature set based on the training set. The system may use the feature set constructor device 112 to construct the feature set. The method then proceeds to step 308 where the system learns the co-ownership decisions based on the feature set and the training set. The system may use the co-ownership decisions learner 116 to learn the co-ownership decisions. The method 300 is then at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to obtaining redirect URL pairs from the Internet, constructing a training set using the redirect URL pairs, constructing a feature set based on the training set, and learning co-ownership decisions based on the feature set and the training set, according to processes of the present invention.

### Advantages

The above invention is intended to be at the core of the redirect policy of a search engine. The redirect policy attempts simultaneously to match the intention of the webmasters and to provide a desirable user experience. By re-structuring the policy based on co-ownership decisions, the present invention improves both the webmaster experience and the user experience.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of identifying if two websites are co-owned, the method comprising:
obtaining redirect uniform resource locator pairs from the Internet;
constructing a training set using the redirect uniform resource locator pairs;
constructing a feature set based on the training set; and
learning co-ownership decisions based on the feature set and the training set.

2. The method of claim 1, wherein each redirect uniform resource locator pair includes a source uniform resource locator and a target uniform resource locator, wherein the source uniform resource locator redirects to the target uniform resource locator.

3. The method of claim 1, wherein constructing the training set comprises:
obtaining registration information from a Whois registrar feed; and
outputting a judgment about each redirect uniform resource locator pair based on the registration information.

4. The method of claim 1, wherein constructing the training set comprises:
receiving human editorial input about the redirect uniform resource locator pairs; and
outputting a judgment about each redirect uniform resource locator pair based on the human editorial input.

5. The method of claim 1, wherein the constructing the feature set comprises analyzing uniform resource locator overlap of each redirect uniform resource locator pair.

6. The method of claim 1, wherein the constructing the feature set comprises analyzing domain server overlap of each redirect uniform resource locator pair.

7. The method of claim 1, wherein the constructing the feature set comprises analyzing uniform resource locator anchor text overlap of each redirect uniform resource locator pair.

8. The method of claim 1, wherein the constructing the feature set comprises analyzing uniform resource locator anchor text overlap of each redirect uniform resource locator pair.

9. The method of claim 1, wherein the constructing the feature set comprises analyzing uniform resource locator anchor text overlap of each redirect uniform resource locator pair.

10. The method of claim 1, wherein the constructing the feature set comprises analyzing spamness and goodness of each redirect uniform resource locator pair.

11. The method of claim 1, wherein the constructing the feature set comprises comparing a title in each target with each respective source of each redirect uniform resource locator pair.

12. The method of claim 1, wherein the learning the co-ownership decisions comprises using a standard machine learning model to learn the co-ownership decisions.

13. An apparatus for identifying if two websites are co-owned, the apparatus comprising:
a web crawler device configured to obtain redirect uniform resource locator pairs from the Internet;
a training set constructor device configured to construct a training set using the redirect uniform resource locator pairs;
a feature set constructor device configured to construct a feature set based on the training set; and
a co-ownership decisions learner device configured to learn co-ownership decisions based on the feature set and the training set.

14. The apparatus of claim 13, wherein each redirect uniform resource locator pair includes a source uniform resource locator and a target uniform resource locator, wherein the source uniform resource locator redirects to the target uniform resource locator.

15. The apparatus of claim 13, wherein the training set constructor device is further configured to:
obtain registration information from a Whois registrar feed; and
output a judgment about each redirect uniform resource locator pair based on the registration information.

16. The apparatus of claim 13, wherein the training set constructor device is further configured to:
receive human editorial input about the redirect uniform resource locator pairs; and
output a judgment about each redirect uniform resource locator pair based on the human editorial input.

17. The apparatus of claim 13, wherein the feature set constructor device is further configured to analyze uniform resource locator overlap of each redirect uniform resource locator pair.

18. The apparatus of claim 13, wherein the feature set constructor device is further configured to analyze domain server overlap of each redirect uniform resource locator pair.

19. The apparatus of claim 13, wherein the feature set constructor device is further configured to analyze uniform resource locator anchor text overlap of each redirect uniform resource locator pair.

20. The apparatus of claim 13, wherein the feature set constructor device is further configured to analyze uniform resource locator anchor text overlap of each redirect uniform resource locator pair.

21. The apparatus of claim 13, wherein the feature set constructor device is further configured to analyze uniform resource locator anchor text overlap of each redirect uniform resource locator pair.

22. The apparatus of claim 13, wherein the feature set constructor device is further configured to analyze spamness and goodness of each redirect uniform resource locator pair.

23. The apparatus of claim 13, wherein the feature set constructor device is further configured to compare a title in each target with each respective source of each redirect uniform resource locator pair.

24. The apparatus of claim 13, wherein the co-ownership decisions leaner device is further configured to use a standard machine learning model to learn the co-ownership decisions.

25. A computer readable medium carrying one or more instructions for identifying if two websites are co-owned, wherein the one or more instructions, when executed by one or more processors, cause the one or more processors to perform the steps of:
obtaining redirect uniform resource locator pairs from the Internet;
constructing a training set using the redirect uniform resource locator pairs;
constructing a feature set based on the training set; and
learning co-ownership decisions based on the feature set and the training set.
